(19) United States
(12) Patent Application Publication
(10) Pub. No.: US 2008/0258489 A1
(43) Pub. Date: Oct. 23, 2008

(54) Safety Device for a Motor Vehicle

(75) Inventors: Martin Ebner, Leonberg (DE); Oliver Reinhardt, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/664,253

(22) PCT Filed: Sep. 29, 2005
(86) PCT No.: PCT/EP05/10516

§ 371 Date: Feb. 13, 2008

(30) Foreign Application Priority Data
Oct. 1, 2004 (DE) 10 2004 047 863.5

(51) Int. Cl. B60N 3/00; B60Q 1/00; B62D 39/00

(52) U.S. Cl. 296/77.1; 362/487; 296/1.04

(57) ABSTRACT

A safety device for a motor vehicle with a front portion and at least two headlamps spaced apart from each other is described. The vehicle includes a front hood which, in an accident, is displaced from its closed initial position into a raised safety position in which a gap is formed between the front hood and the front portion. To increase pedestrian protection, in the regions of the headlamps the safety device includes at least one covering element which is movable between a retracted position and an extended position in which the gap is closed by the covering element.

### CROSS REFERENCE TO RELATED APPLICATIONS

This application is a national stage of PCT International Application No. PCT/EP2005/010516, filed Sep. 29, 2005, which claims priority under 35 U.S.C. § 119 to German Patent Application No. 10 2004 047 863.5, filed Oct. 1, 2004, the entire disclosures of which are herein expressly incorporated by reference.

### BACKGROUND AND SUMMARY OF THE INVENTION

The invention relates to a safety device for a motor vehicle with a front portion, which comprises at least two headlamps which are spaced apart from each other in the transverse direction of the vehicle, and with a front hood, which, in an accident situation, is displaced from its closed initial position into a raised safety position in which a gap is produced between the front hood and the front portion.

A safety device of this type is known, for example, from German laid-open specification DE 100 14 832 A1. This document describes a front hood which, in an accident situation, is displaced from its closed initial position into a raised safety position in order to provide a deformation distance. The known safety device comprises an airbag which is arranged below the front hood. When the front hood is raised, the airbag is filled. The filled airbag covers a gap, which occurs in the safety position of the front hood, between the body and front hood in the lateral region of the front hood.

According to the invention, there is provided a safety device for a motor vehicle with a front portion, which comprises at least two headlamps which are spaced apart from each other in the transverse direction of the vehicle, and with a front hood, which, in an accident situation, is displaced from its closed initial position into a raised safety position in which a gap is produced between the front hood and the front portion in such a manner that pedestrian protection is increased.

The invention provides a safety device for a motor vehicle with a front portion, which comprises at least two headlamps which are spaced apart from each other in the transverse direction of the vehicle, and with a front hood, which, in an accident situation, is displaced from its closed initial position into a raised safety position in which a gap is produced between the front hood and the front portion in the regions of the headlamps. The safety device comprises in general at least one covering element which is movable between a retracted position and an extended position in which the gap is closed by the covering element. The construction space in the region of the headlamps is reduced because of the design. The front hood's curving contour, which is provided in many motor vehicles in order to reduce the drag, has the effect that the gap which occurs on the front portion when the front hood is raised is greatest in the region of the headlamps. The gap in the region of the headlamps is closed in a simple manner by the covering elements according to the invention.

A preferred exemplary embodiment of the safety device includes a covering element that is pivotable between the retracted and the extended position. The pivoting movement can be produced by an actuator and can be limited by a stop.

A further preferred exemplary embodiment of the safety device includes a pivot axis of the covering element arranged behind the covering element, as viewed in the longitudinal direction of the vehicle. This affords the advantage that, in the case of an impact from the front, the covering element is not pushed out of the extended position back into the retracted position.

A further preferred exemplary embodiment of the safety device includes a covering element fastened to the ends of two levers which are mounted pivotably on the front portion. The lever arms may also be mounted on the front hood. Depending on the construction space and size of the gap, it is also advantageous, under some circumstances, in the region of the headlamp to fit a covering element to the front portion, for example to a headlamp housing, and to fit a further covering element to the front hood.

A further preferred exemplary embodiment of the safety device includes lever arms that are mounted on a headlamp housing. The lever arms may also be mounted on a radiator cross member or on a wing of the vehicle.

A further preferred exemplary embodiment of the safety device includes a headlamp housing with a raised part behind which, as viewed in the direction of travel, the covering element is arranged in its retracted position. A step is preferably provided in the upper side of the headlamp housing, as viewed in longitudinal section, the step being used to receive the covering element together with the mounting.

A further preferred exemplary embodiment of the safety device includes a covering element prestressed into the extended position by a spring arrangement. This ensures in a simple manner that the covering element assumes its extended position as soon as the front hood is raised. Furthermore, deflection of the front hood during opening or closing is not impaired by the spring arrangement.

A further preferred exemplary embodiment of the safety device includes a spring arrangement which comprises at least one leaf spring, the one end of which is fastened to one of the lever arms. The other end of the leaf spring is preferably supported on the headlamp housing. However, depending on where the covering element is mounted, the other end of the leaf spring may also be supported on the radiator cross member, the wing or the front hood.

A further preferred exemplary embodiment of the safety device includes a further covering element provided in the region between the headlamps. The further covering element is used to close the gap between front hood and front portion in the region between the headlamps.

A further preferred exemplary embodiment of the safety device has the further covering element angled downward from the front hood. The further covering element is preferably formed by a fold.

Further advantages, features and details of the invention emerge from the description below in which various exemplary embodiments are described in detail with reference to the drawing. The features mentioned in the claims and in the description may each be utilized in the invention by themselves or in any desired combination.

### BRIEF DESCRIPTION OF THE DRAWINGS

In the drawings:

FIG. 1 shows a perspective illustration of a region of an engine compartment of a motor vehicle with the engine hood open;

FIG. 2 shows a plan view of the region illustrated in FIG. 1;

FIG. 3 shows a perspective illustration of the front portion of the motor vehicle, part of which is illustrated in FIGS. 1 and 2;

FIG. 4 shows a sectional view along the line IV-IV shown in FIG. 3, and

FIG. 5 shows a sectional view along the line V-V shown in FIG. 3.

### DETAILED DESCRIPTION OF THE DRAWINGS

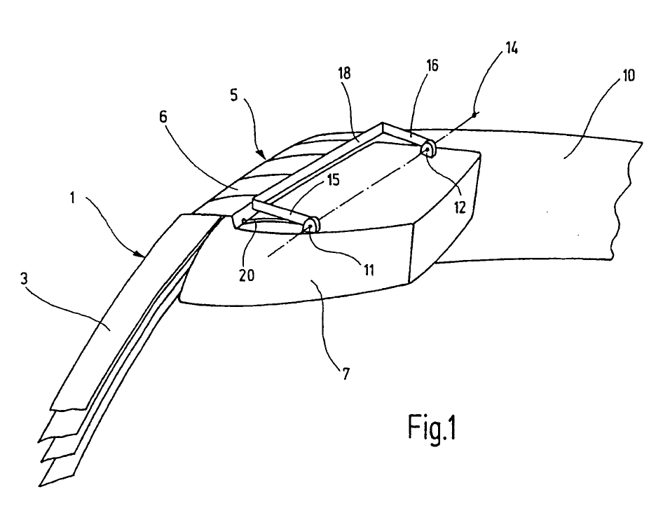

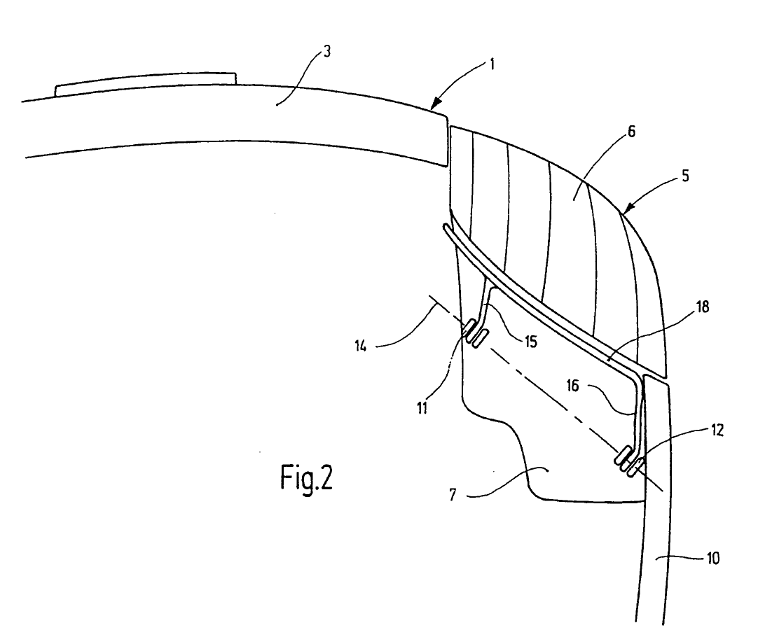

FIGS. 1 and 2 illustrate a region of the engine compartment of a motor vehicle perspectively and in plan view. The motor vehicle is a passenger vehicle with a front portion 1. The front portion 1 includes a radiator grille 3 which is fastened to a supporting structure (not illustrated) of the motor vehicle. Two headlamps, of which only one headlamp 5 is illustrated in FIGS. 1 and 2, are arranged at the sides of the radiator grille 3. The headlamp 5 has a headlamp glass 6 which is fastened in a headlamp housing 7. The headlamp housing 7 is fastened to the supporting structure of the motor vehicle. A wing 10 which laterally delimits the motor vehicle extends laterally from the front portion 1.

Two bearing points 11 and 12 of the safety device according to the invention are provided on the upper side of the headlamp housing 7. The two bearing points 11 and 12 define an axis of rotation 14 which runs parallel to the front edge of the headlamp housing 7. One end of a lever arm 15 is mounted pivotably on the bearing point 11. One end of a lever arm 16 is mounted pivotably on the bearing point 12. The two lever arms 15 and 16 are pivotable about the axis of rotation 14. A gap-covering element 18, which is essentially in the form of an elongate plate, is fastened to the other ends of the lever arms 15 and 16. One end of a leaf spring 20 is fastened to the lever arm 15 and its other end is supported on the headlamp housing 7 in such a manner that that end of the lever arm 15 to which the gap-covering element 18 is fastened is prestressed upward from the upper side of the headlamp housing 7.

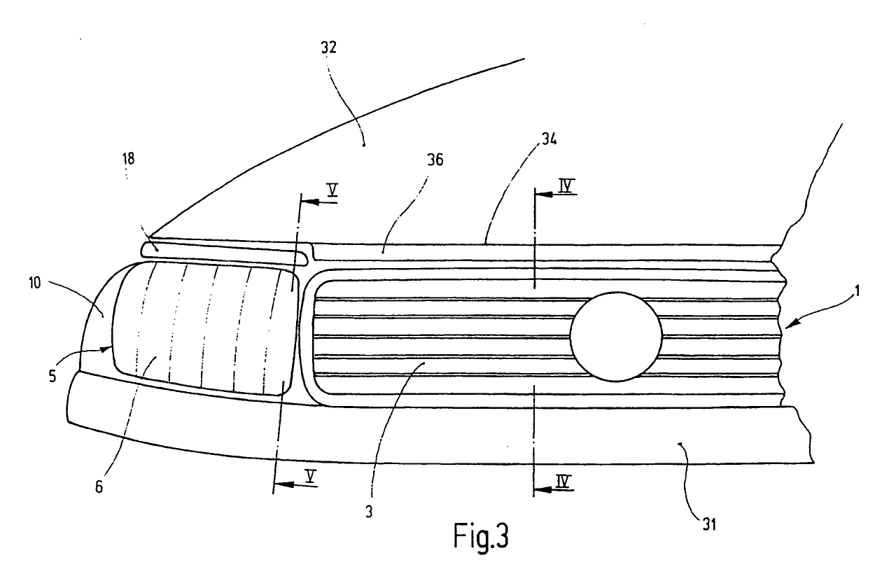

FIG. 3 illustrates the front portion 1 of the motor vehicle in front view. It can be seen in the front view that the front portion 1 is downwardly delimited by a bumper 31. The front portion 1 is upwardly delimited by a front hood 32 which, in FIG. 3, is in its raised position, which is also referred to as the safety position. The front hood 32 is also referred to as the engine hood in the case of vehicles in which the engine is arranged in the region of the front axle. In the region of the headlamp 5, a gap between the upper edge of the headlamp glass 6 and the front edge 34 of the front hood 32 is produced in the front portion, in the raised position of the front hood. The gap in the region of the headlamp 5 is filled by the gap-covering element 18 which is in its extended position in which it is prestressed by the leaf spring (20 in FIG. 1). Between the two headlamps, a gap is likewise formed between the radiator grille 3 and the front edge 34 of the front hood 32, said gap being closed by a fold 36 angled down from the engine hood 32.

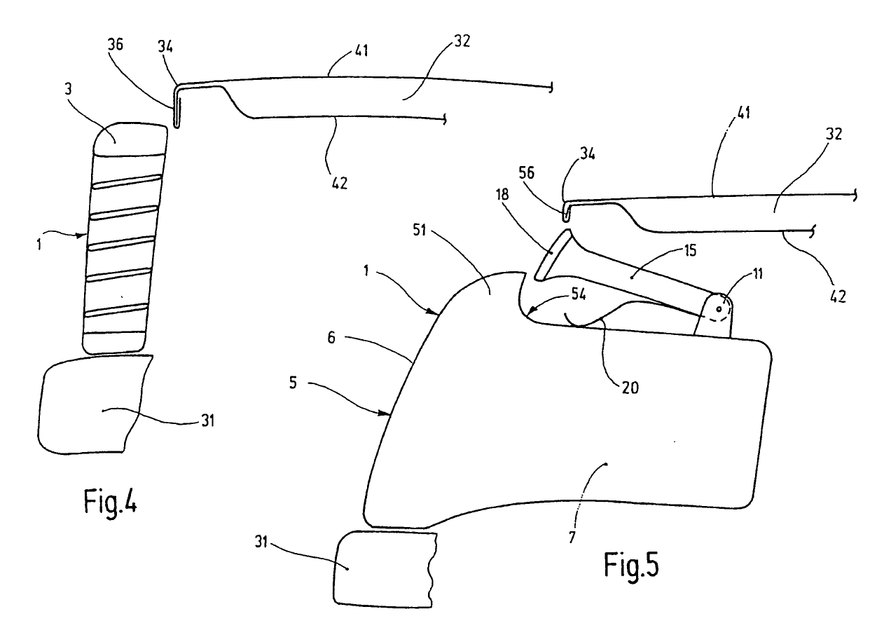

FIG. 4 shows the view of a section along the line IV-IV in FIG. 3. It can be seen in the sectional view that the engine hood 32 is upwardly delimited by an engine hood panel 41 and downwardly delimited by an engine hood inner panel 42. At the front edge 34, the front border of the engine hood panel 41 and the front border of the engine hood inner panel 42 are angled downward at right angles and connected to each other by the fold 36.

FIG. 5 illustrates the view of a section along the line V-V in FIG. 3. It can be seen in the sectional view that the headlamp 5 has, at the top front, as viewed in longitudinal section, a raised portion 51 by which a step 54 is formed in the headlamp housing 7, the step being used to receive the bearing point 11, the lever arm 15 and the gap-covering element 18 when the gap-covering element 18 is moved downward from the extended position illustrated counter to the prestressing force of the leaf spring 20.

Furthermore, it can be seen in FIG. 5 that, in the region of the headlamp 5 too, a fold 56 can be angled downward on the front edge 34 of the front hood 32, but the fold is preferably designed to be smaller than the fold 36 in the region of the radiator grille. Instead of the fold 56, a further covering element can also be fitted pivotably to the front hood 32.

The spring-prestressed gap covering 18 automatically covers the gap, which results during raising of the front hood 32, in the region of the headlamp 5. The arrangement of the axis of rotation 14 counter to the direction of travel behind the gap-covering element 18 ensures that, in the event of an impact from the front, the gap-covering element 18 cannot be pushed away. At the same time, the deflection of the front hood 32 is not obstructed. The design according to the invention permits the gap covering to be shifted in a manner efficient in terms of construction space, without obstructing engine-hood functions which are relevant to pedestrian protection. Separate activation of the covering 18 or actuation of the same can be omitted. The design is simple and is therefore not susceptible to error. The flexibility of being able to use the gap-covering element 18 on the headlamp, engine hood or radiator cross member enables the gap covering to be used efficiently in different vehicle designs.

The gap-covering element 18 can be produced from various materials. Depending on the method of production, it is joined together from a greater or lesser number of individual components. For example, the covering element 18 is formed from fiber-reinforced plastic materials. In this case, the leaf spring 20 can be designed as a projecting, correspondingly designed part of the covering element 18. The covering element 18 may be formed from metal encapsulated with plastic by injection molding. In this case, the favorable rigidity of the metal core is combined with the plastics surface which is uncomplicated with regard to corrosion and damage of engine hood and headlamp. A further possibility is the designing of the covering element 18 as a light metal cast part, for example made from cast aluminum or cast magnesium.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A motor vehicle with a front portion, comprising:
at least two headlamps spaced apart from each other transversally;
a front hood displaceable in an accident from a closed initial position to a raised safety position in which a gap is formed between the front hood and the front portion; and
at least one covering element movable between a retracted position and an extended position in which the gap is closed by the covering element.

12. The motor vehicle as claimed in claim 11, wherein the covering element is pivotable between the retracted and the extended position.

13. The motor vehicle as claimed in claim 12, wherein a pivot axis of the covering element is arranged longitudinally behind the covering element.

14. The motor vehicle as claimed in claim 13, wherein the covering element is fastened to ends of two lever arms mounted pivotably on the front portion.

15. The motor vehicle as claimed in claim 14, wherein the two lever arms are mounted on a headlamp housing.

16. The motor vehicle as claimed in claim 15, wherein the headlamp housing comprises a raised part behind which the covering element is arranged, in the retracted position.

17. The motor vehicle as claimed in claim 11, wherein the covering element is urged into the extended position by a spring arrangement.

18. The motor vehicle as claimed in claim 17, wherein the spring arrangement comprises at least one leaf spring, one end of which being fastened to one of a pair of lever arms.

19. The motor vehicle as claimed in claim 11, further comprising a further covering element provided in the region between the headlamps.

20. The motor vehicle as claimed in claim 19, wherein the further covering element is angled downward from the front hood.

21. The motor vehicle as claimed in claim 11, wherein the at least one covering element is disposed adjacent to one of the headlamps.

22. A safety device for a front hood of a vehicle, comprising:
a covering element movable between a retracted position and an extended position, wherein in the extended position the covering element closes a gap formed between a front portion of the vehicle and a front hood of the vehicle displaced in an accident condition;
a lever arm of the covering element that attaches the covering element to the front portion of the vehicle and that opposes displacement from the extended position in the accident condition; and
an actuating element that urges the covering element in the extended position in the accident condition.

23. The safety device according to claim 22, further comprising a spring element that urges the covering element in the extended position.

24. The safety device according to claim 22, wherein the covering element is pivotally attached to the front portion of the vehicle.

25. The safety device according to claim 24, wherein the lever arm is pivotally attached to a headlamp housing.

26. The safety device according to claim 22, wherein the covering element is formed of one of a fiber reinforced plastic material and a metal encapsulated in a plastic material.

27. The safety device according to claim 22, wherein the covering element extends substantially along a width of a headlamp housing.

28. The safety device according to claim 22, wherein the covering element extends substantially between two headlamp housings.

29. The safety device according to claim 22, wherein a pivot axis of the covering element lies longitudinally behind the covering element.
